(19) United States
(12) Patent Application Publication
(10) Pub. No.: US 2023/0221155 A1
(43) Pub. Date: Jul. 13, 2023

(54) METHOD AND MEASURING DEVICE FOR DETERMINING A MEASURED QUANTITY RELATING TO A FLOW

(71) Applicant: Diehl Metering GmbH, Ansbach (DE)

(72) Inventors: Andreas Benkert, Ansbach (DE); Roland Horn, Weihenzell (DE); Marcus Wetzel, Heilsbronn (DE); Andreas Madinger, Ansbach (DE); Michael Mayle, Ansbach (DE)

(21) Appl. No.: 18/152,466

(22) Filed: Jan. 10, 2023

(30) Foreign Application Priority Data
Jan. 12, 2022 (DE) 10 2022 100 677.8

(51) Int. Cl. G01F 1/667; G01F 1/7082; G01F 1/712

(52) U.S. Cl. CPC G01F 1/667; G01F 1/7082; G01F 1/712

(57) ABSTRACT

A method determines a measured quantity relating to the flow of a fluid through a measuring tube, in two propagation directions, and a receive signal is captured. A transit time difference is determined depending on the position of the main maximum of a cross-correlation of the receive signals. Whereupon the measured quantity is determined depending on the transit time difference, and the transmitting ultrasonic transducer is controlled in each case with an excitation signal. The excitation signal has a fixed carrier frequency. The excitation signal has a phase shift and/or an envelope with a plurality of temporally spaced maxima, and/or, if a trigger condition is fulfilled, the fulfilment of which depends on the height of the main maximum and/or of at least one secondary maximum of the cross-correlation. The determination of the measured quantity is modified compared with a normal operating mode and/or a message is output.

### CROSS-REFERENCE TO RELATED APPLICATION

This application claims the priority, under 35 U.S.C. § 119, of German Patent Application DE 10 2022 100 677.8, filed Jan. 12, 2022; the prior application is herewith incorporated by reference in its entirety.

### FIELD AND BACKGROUND OF THE INVENTION

The invention relates to a method for determining a measured quantity relating to the flow of a fluid through a measuring tube by means of a measuring device, wherein, for two propagation directions, an ultrasonic signal is emitted in each case by a transmitting ultrasonic transducer of the measuring device and is transmitted via the fluid to a receiving ultrasonic transducer of the measuring device. A receive signal is captured via the respective receiving ultrasonic transducer for the respective propagation direction, wherein, depending on the position of the main maximum of a cross-correlation of the receive signals for the two propagation directions or a cross-correlation of processing signals which depend in each case on one of the receive signals or on a partial signal of the respective receive signal. A transit time difference between the transit times of the respective ultrasonic signal for the respective propagation direction from the respective transmitting ultrasonic transducer to the respective receiving ultrasonic transducer is determined, whereupon the measured quantity is determined depending on the transit time difference. The transmitting ultrasonic transducer is controlled in each case with an excitation signal. The invention further relates to a measuring device.

In the case of ultrasonic-based flow measurements, it is well known for a respective transit time from a transmitting to a receiving ultrasonic transducer to be measured in the direction of flow and against the direction of flow, and for the flow rate or, if the flow geometry is known, the volume flow, to be determined from the transit time difference between these transit times. A common approach here for determining the respective transit time is to determine an envelope of the receiving ultrasonic signal, for example through rectification and low-pass filtering, and to identify the start of the incoming wave by means of a comparator. However, in principle, only very low time resolutions are hereby achieved, since the phase position of the receive signal is not taken into account. Relatively long measuring distances are therefore required in order to achieve high accuracy.

In order to improve the time resolution, published non-prosecuted German patent application DE 10 2009 046 562 A1 proposes the use of a transmit pulse with a changing carrier frequency in each case for both transmission directions. If the frequency change characteristics of the received signals are then determined and correlated with one another for the two propagation directions, a transit time difference can hereby be determined with a good time resolution.

However, the disadvantage of this procedure is that an excitation with a changing excitation frequency is technically relatively complex and an excitation must further be performed with a frequency other than the resonant frequency, at least for a part of the excitation interval, as a result of which a higher energy consumption is required in order to achieve the same excitation amplitudes. Moreover, an excitation with a time-variable carrier frequency is not suitable for all measuring devices. If, for example, an indirect excitation of the fluid is to be implemented by first exciting a Lamb wave in a tube wall, which in turn excites compression waves in the fluid, different excitation frequencies result in different Rayleigh angles and therefore different propagation paths of the compression wave in the fluid, and for this reason it is not possible or not readily possible to determine a flow from receive signals resulting therefrom.

### SUMMARY OF THE INVENTION

The object of the invention is therefore to indicate a possibility for determining a transit time difference which is used to determine a measured quantity relating to the flow of a fluid with high-resolution, wherein the problems explained above resulting from a change in the carrier frequency within the excitation pulse are intended to be at least largely avoided.

The object is achieved according to the invention by a method of the aforementioned type, wherein, on one hand, the excitation signal has a fixed carrier frequency. The excitation signal has a phase shift and/or an envelope with a plurality of temporally spaced maxima, and/or wherein, on the other hand, if a trigger condition is fulfilled, the fulfilment of which depends on the height of the main maximum and/or of at least one secondary maximum of the cross-correlation, the determination of the measured quantity is modified compared with a normal operating mode and/or a message is output to a user of the measuring device and/or to a further device outside the measuring device.

The proposed method allows the transit time difference to be determined robustly and with high resolution, even without changing the carrier frequency of the excitation signal, so that the measured quantity can also be determined robustly and with high accuracy. In principle, the cross-correlation already takes account of the phase position of the receive signals, resulting in a high time resolution for the transit time difference. If the excitation signal were emitted continuously as a periodic signal, the transit time difference could not be clearly determined since a plurality of maxima having the same height would occur at an interval equal to the period of the excitation signal. However, the use of a finite-length excitation and therefore also a time-variable envelope already results in the occurrence of a clear main maximum of the cross-correlation in the case of interference-free or sufficiently low-interference measurements, and the secondary maxima have a markedly lower height than the main maximum, so that a clear transit time difference is determinable.

However, a problem arises here in that, with normal excitation signals which comprise, for example, ten oscillation periods within a rectangular envelope, the heights of the main maximum and the adjacent secondary maxima differ only relatively slightly from one another. Furthermore, since ultrasonic signals have a relatively high frequency, for example an excitation frequency of 1 MHz, and therefore only a relatively small number of measuring points are recorded per oscillation cycle in the case of commonly used sample rates of, for example, 8 MHz for digitising the receive signals, even smaller differences between the height of the main maximum and the secondary maxima frequently occur in real applications, so that even relatively minor interference can result in one of the secondary maxima being misidentified as the main maximum. However, this results in a very substantial measurement error for the determined measured quantity and must therefore be avoided in order to achieve adequate robustness in the measured quantity recording.

It has been recognized according to the invention that the use of a phase shift in the excitation signal or the use of an envelope with a plurality of temporally spaced maxima significantly reduces the relative heights of the secondary maxima of the cross-correlation compared with the height of the main maximum, so that a detection of the main maximum and therefore a significantly more robust determination of the transit time difference are therefore possible. The reason for this is that, in both cases, a receive signal offset by one period in relation to the other receive signal which results in the first secondary maximum already significantly reduces the integral of the product of the receive signals shifted in this way in relation to one another. The phase shift of the excitation signal in fact results in a phase shift in the receive signals so that they no longer overlap one another phase-synchronously in some areas. A shift in the maxima of the envelope of the receive signals in relation to one another, resulting from the choice of the described envelope for the excitation signal, also results in a lowering of the height of the secondary maxima. The overall measurement is substantially less prone to error as a result.

In principle, however, it is also possible, even without such a phase shift of the excitation signal or with the use of an envelope with only one maximum, through the use of the trigger condition, to detect corresponding interference in the measurement which would otherwise result in errors in the measured quantity and, for example, if the trigger condition is fulfilled, to reject the measurement or modify the determination of the measured quantity, as will be explained in more detail later. However, the evaluation of the trigger condition can also be used for other purposes, particularly if a phase shift or an envelope with a plurality of temporally spaced maxima is used, for example to further improve the measurement accuracy, to detect ageing processes and the like. The checking of the trigger condition is also appropriate for carrying out a quality control during manufacture and/or following the installation of the measuring device and, e.g. if the trigger condition is fulfilled, to output a message indicating that the measuring device or its installation does not meet predefined quality requirements.

The main maximum is the global maximum of the cross-correlation, whereas the secondary maxima are local maxima. However, interference in the measurement, e.g. due to noise and/or a limited temporal resolution in the capture of the receive signals, can result in receive signals for whose cross-correlation the height of a local maximum, which would be a secondary maximum in the case of an interference-free measurement, exceeds the height of the local maximum which would be the main maximum in the case of an interference-free measurement. This is also referred to here for short as misidentification of the main maximum or its position. Corresponding interference is intended to be suppressed or at least identified by the described procedure.

In particular, in the method according to the invention, the ultrasonic transducer which is used as the transmitting ultrasonic transducer for the first propagation direction can be used as the receiving ultrasonic transducer for the second propagation direction and/or the ultrasonic transducer which is used as the receiving ultrasonic transducer for the first propagation direction can be used as the transmitting ultrasonic transducer for the second propagation direction. The method according to the invention can therefore be carried out with precisely two ultrasonic transducers which are used in each case as the transmitting ultrasonic transducer for one of the propagation directions and as the receiving ultrasonic transducer for the other propagation direction.

Alternatively, however, it is also possible to use an ultrasonic transducer which is not used in the measurement for the first propagation direction for the emission of the ultrasonic signal and/or for the reception of the receive signal for the second propagation direction. The same ultrasonic transducer can be used, for example, for the first propagation direction and the second propagation direction to transmit the respective ultrasonic signal, wherein, for example, a further ultrasonic transducer located upstream of this ultrasonic transducer is used as the receiving ultrasonic transducer for the first propagation direction, and a further ultrasonic transducer arranged downstream of this ultrasonic transducer is used for the second propagation direction.

The ultrasonic transducers can be arranged in or on the measuring tube and can excite the fluid either directly or indirectly. An indirect excitation can be implemented, for example, by initially exciting a guided wave, for example a Lamb wave, in the measuring tube wall which excites compression waves in the fluid along its propagation path. The reception can also be implemented accordingly either directly by the receiving ultrasonic transducer or indirectly, for example via a tube wall.

In particular, a flow rate of the fluid and/or a volume flow can be determined as the measured quantity.

If a cross-correlation of processing signals is used, the respective processing signal or an intermediate signal from which the processing signal is determined can be generated or selected, for example, by taking account exclusively of parts of the measured values of the respective receive signal, for example by recording only those measured values which have been recorded during a specific subinterval of the time interval during which the receive signal was captured. The computing requirement and therefore the energy requirement for calculating the cross-correlation can be reduced through the restriction to a partial signal. Additionally or alternatively, for example, an up-sampling, an interpolation, a filtering and/or a scaling can be implemented in order to determine the respective processing signal.

In cases where an envelope without a plurality of temporally spaced maxima is used, the envelope can, in the simplest case, be a rectangular function, i.e. it can serve to activate and deactivate the excitation signal. However, complex-shaped envelopes, for example pulse sequences or envelopes which have slopes which differ from section to section, can also be used, particularly if an envelope with a plurality of temporally spaced maxima is intended to be used.

Regardless of whether an envelope with a plurality of temporally spaced maxima is used, the amplitude characteristic of the excitation signal can be predefined, for example, through initial predefinition or generation of the excitation signal with a fixed amplitude, followed by an amplitude modulation by means of a separately predefined envelope. Alternatively, however, an excitation signal having the desired amplitude characteristic or the desired envelope can be generated or predefined, for example, directly.

In particular, the excitation signal can have the resonant frequency of the transmitting and/or the receiving ultrasonic transducer. However, other excitation frequencies can also be used. The carrier frequency can be selected, for example, in such a way that it produces the maximum amplitude of the receive signal for a given amplitude of the excitation. However, as will be explained later, the choice of the carrier frequency can also serve to maximize the size of phase shifts in the receive signal.

The evaluation of the trigger condition can serve to detect distortions in one of the receive signals, wherein such distortions result, in particular, in a reduction in the height of the main maximum, since, in this case, the receive signals have shapes which differ significantly from one another. Distortions of this type can be caused, for example, by damage to one of the ultrasonic transducers or the assigned electronics, or from misalignment of the components with one another. Distortions can also be caused by interference-affected sound transmission paths, for example if the ultrasonic transducers are not coupled correctly with the measuring tube or other components, or air, particles or the like are present in the measuring tube. A lack of electromagnetic compatibility of the components of the measuring device or components arranged in the environment of the measuring device, for example due to manipulation attempts on a flow meter, can also result in corresponding distortions or a reduction in the height of the main maximum.

While the described processes typically result in a significant reduction in the height of the main maximum and should, for example, trigger a notification of required maintenance or should result in the current measurement being rejected, high flow rates in the measuring tube normally also result in a lowering of the height of the main maximum so that the height of the main maximum or the trigger condition can also be evaluated, for example, in order to make adjustments to the measurement operation or corrections in the case of high flow rates.

The height of the secondary maximum, in particular compared with the height of the main maximum, can be evaluated, in particular, in order to assess how robustly the main maximum has been identified in the current measurement. A potential misidentification of the main maximum can thus be identified and, for example, the measurement can be repeated as necessary.

If the trigger condition is fulfilled, the determination of the measured quantity can be modified compared with the normal operating mode in such a way that, on one hand, the receive signals are rejected and either a previously determined measured quantity is used as the current measured quantity or the determination of the receive signals is repeated in order to provide new receive signals, wherein the determination of the new receive signals is performed either unchanged or with at least one modified determination parameter compared with the determination of the receive signals, and the measured quantity is determined on the basis of the new receive signals, and/or that, on the other hand, the transit time difference is determined depending on the position of one of the secondary maxima of the cross-correlation and/or a determination rule is modified in order to determine the measured quantity from the transit time difference.

As already explained above, the trigger condition can be fulfilled due to interference or manipulation which can be identified, for example, due to the presence of very similar heights of the main maximum and at least one secondary maximum and/or a significantly reduced height of the main maximum. In this case, it is appropriate to reject the measurement. Depending on the clock timing of the measurement in normal operation, a sufficient time reserve can be available here for repeating the measurements.

It can suffice to repeat the determination of the receive signals unchanged, e.g. if the trigger condition has been fulfilled due to short-term interference. On the other hand, it can be advantageous to modify determination parameters during the repetition in order to be able to respond to a fulfilment of the trigger condition due to longer-lasting interference or changes in the measurement conditions also. The carrier frequency of the excitation signal, for example, and/or the size of the phase shift can be modified as measurement parameters, as will be explained later. However, it is also possible to modify the envelope, for example the time interval of the maxima and/or the maximum amplitude, and/or the sensitivity of the capture of the receive signals.

In other cases, for example if measurements are carried out in any case at a relatively short time interval and no overly strong fluctuations in the measured quantity are to be expected, the previously determined measured quantity can also continue to be used instead of a newly determined measured quantity, which can be appropriate, for example, if a volume flow determined as the measured quantity is intended to be integrated over time, or the like.

However, as similarly already mentioned above, a high flow rate of the fluid through the measuring tube can also result in the fulfilment of the trigger condition. This can be identified, for example, if a relatively even lowering of the height of the main maximum and secondary maxima occurs. In this case, it can be appropriate to adapt the determination rule for determining the measured quantity from the transit time difference, for example if it can be assumed on the basis of a known flow geometry in the measuring tube that a different relationship exists, due to a change in the flow profile at high flow rates, between the transit time difference which typically results primarily from the flow rate in a specific area of the measuring tube and the flow quantity. A different scaling factor, for example, or a different look-up table, a different mathematical relationship, or the like, can be used depending on whether the trigger condition is fulfilled or not.

A special case occurs here if the main maximum and at least one secondary maximum have relatively similar heights i.e., for example, a height difference or quotient falls below a limit value. It is possible, for example, that the lowering of the main maximum indicates a high flow and, at the same time, the transit time determined from the position of the main maximum indicates a low flow. In this case, it can be appropriate to use a secondary maximum to determine the transit time difference instead of the position of the main maximum which has probably been identified on the basis of a misidentification, wherein the secondary maximum is probably the actual main maximum which has been identified as a secondary maximum only as a result of interference.

If the trigger condition is fulfilled and/or a spectral condition depending on a spectral composition of at least one of the receive signals is fulfilled, a second determination of the receive signals can be carried out following a first determination of the receive signals. The carrier frequency of the excitation signal and/or the size of the phase shift is modified compared with the first determination. In particular, the transit time difference can then be determined depending on the measurement data of the second determination. However, it is also possible to continue the checking of the trigger condition or the spectral condition for the respective current measurement data until the respective condition is no longer fulfilled or a termination condition, for example a maximum number of attempts, is fulfilled, and then e.g. the most recently determined receive signals are used to determine the transit time difference.

Due to ageing or damage to components of the measuring device, or due to ambient conditions, for example temperature, the resonant frequency of one of the ultrasonic transducers or of both ultrasonic transducers can shift and/or a transfer function for an entire transmission path between the ultrasonic transducers can change. The optimum measurement conditions can also change as a result, which can be identified by checking the trigger condition or the spectral condition. The optimum measurement conditions can then be reinstated by adjusting the carrier frequency or the size of the phase shift.

In a simple example, an excitation at the resonant frequency can be desirable in order to achieve a maximum amplitude of the receive signal for a given amplitude of the excitation. If the resonant frequency of an ultrasonic transducer then shifts or the transfer function changes, this can result in a reduced amplitude of the receive signals which, if no normalisation of the receive signals or of the cross-correlation is performed, also reduces the height of the main maximum and secondary maxima of the cross-correlation. This can be identified by means of the trigger condition, and the excitation signal to be used can thus be redefined, in particular a corresponding carrier frequency can be chosen in order to achieve the maximum amplitude once more.

Through the evaluation of the spectral composition in connection with the spectral condition, it is possible to identify, for example, if the excitation of the ultrasonic signals takes place at a frequency which does not correspond to the resonant frequency of the transmitting or the receiving ultrasonic transducer. As already explained, for example, in the above-mentioned published, non-prosecuted German patent application DE 10 2009 046 562 A1, this results in this case in an overlay of the excitation frequency and the resonant frequency, which can easily be identified in the spectral composition.

The fulfilment of the spectral condition can depend, for example, on the frequency range in which frequencies have the maximum amplitude in the respective receive signal or in a selected time segment of the respective receive signal. If, for example, dominant frequencies occur in the decay phase of the receive signal which do not correspond to the excitation frequency or carrier frequency, this points to a secondary resonant excitation. A spectral condition of this type can be evaluated, for example, by transforming the receive signal or the time segment into the frequency space and by searching there for maxima. If a particularly high frequency resolution is not desired, it may be appropriate to combine adjacent frequency ranges here into larger frequency ranges, which is also referred to as binning, in order to improve robustness.

In the method according to the invention, it is possible for the receive signals to be determined multiple times in temporal succession for the propagation directions and the respective cross-correlation, wherein a time characteristic of the height of the main maximum and/or at least one of the secondary maxima of the cross-correlation and/or a time characteristic of a processing result depending on the heights of the main maximum and at least one of the secondary maxima is recorded, wherein the fulfilment of the trigger condition depends on the respective time characteristic.

In particular, ageing processes of components, in particular the ultrasonic transducers, can be identified by recording the time characteristic of at least one of the aforementioned quantities. This can be appropriate, for example, for adjusting the operation of the measuring device with the ageing of the components and/or for outputting a maintenance-related notification to a user or to an external device, for example of the manufacturer of the measuring device or of a measurement service company, in a timely manner before a corresponding ageing results in an unacceptable deterioration in measurement accuracy. However, consideration of the characteristic of at least one of the aforementioned quantities can also be advantageous in order to be able to distinguish between a change in the aforementioned quantities due to ageing and a sudden change, for example due to specific interference or a manipulation attempt.

A test ultrasonic signal can be emitted multiple times by the respective transmitting ultrasonic transducer and can be transmitted via the fluid to the respective receiving ultrasonic transducer for at least one of the propagation directions before the emission of the respective ultrasonic signal, wherein a respective test receive signal is captured via the respective receiving ultrasonic transducer. The respective transmitting ultrasonic transducer is controlled to emit the respective test ultrasonic signal in each case with a test excitation signal, in particular amplitude-modulated by the envelope. The test excitation signals differ from one another in terms of their carrier frequency and/or the size of their phase shift. The test excitation signal for which the maximum phase shift and/or the maximum separation of local maxima of an envelope of the test receive signal occur in the resulting test receive signal is chosen as the excitation signal for determining the transit time difference. A measure of the separation of the maxima of the envelope can depend on the temporal spacing of the maxima and/or on a minimum height of the envelope between the maxima. In particular, this measure can depend on the ratio of this minimum height to the height of one of the adjacent local maxima, in particular the lower of the maxima.

A substantial phase shift in the receive signals or a strong separation of the local maxima of the envelope of the receive signals results in substantial suppression of the secondary maxima in the case of a cross-correlation of receive signals or processing signals determined therefrom. Thus, as a result of the described process, the test excitation signal during the use of which the main maximum differs particularly significantly from the secondary maxima is chosen as the excitation signal, thereby enabling a particularly robust determination of the transit time difference and therefore the measured quantity.

The described choice of the excitation signal from a plurality of test excitation signals can be used as a one-off to calibrate the measuring device, for example immediately after its manufacture or following its installation. However, it is also possible to repeat this selection under certain conditions, for example after fulfilment of the trigger condition and/or the spectral condition and/or after specific time periods or after determining a specific degree of ageing.

The size of the phase shift can be determined by performing a Fourier transform in each case for a plurality of windows of the respective test receive signal. A phase can be determined through Fourier transforms for each of these windows, i.e. for the different time segments of the test receive signal, for each of the frequencies contained in the test receive signal. A substantial change in the phase of the dominant frequency between adjacent windows corresponds to the phase shift, so that the phase shift can be calculated directly by subtracting the relative phase positions. Alternatively, it would be possible, for example, to determine the phase shift directly by fitting a respective sine function, in particular with an envelope, to a part of the receive signal before and after the phase shift.

The fulfilment of the trigger condition can depend on the difference and/or the quotient of the height of the main maximum and the height of one of the secondary maxima, in particular the highest secondary maximum. In particular, the trigger condition can depend on a comparison of one of these quantities with a limit value. If the main maximum is absolutely or relatively sufficiently greater than all secondary maxima or the highest secondary maximum, this indicates a high robustness in the detection of the main maximum. Otherwise, the trigger condition can be fulfilled, for example, in order to indicate interference which could result in uncertain identifiability of the main maximum, or in order to improve the robustness through a changed determination of the measured quantity.

In the case where the fulfilment of the trigger condition depends on the height of the main maximum and/or the secondary maximum of the cross-correlation of the processing signals, the respective processing signal can be determined through normalisation of the respective receive signal or of a respective intermediate signal determined from the receive signal. Additionally or alternatively, the height of the main maximum and/or the secondary maximum of the cross-correlation can be determined following a normalisation of the cross-correlation.

By means of a normalisation, the values of the respective receive signal or processing signal or of the cross-correlation are scaled by a predefined factor. A specific value, e.g. the respective global maximum, can be scaled, for example, to a predefined value, e.g. one, and the further values can be scaled by the same scaling factor. In the case of the normalization of the cross-correlation, all values can be scaled by a scaling factor depending on the amplitudes of the two autocorrelations of the two cross-correlated receive signals or processing signals. In particular, a scaling factor can be used which is inversely proportional to the root of the product of the amplitudes of the autocorrelations.

Following a suitable normalization, the cross-product is essentially independent from the amplitude of the input signals and therefore relates only to a similarity or temporal shift of the input signals in relation to one another. The intermediate signal can be determined, for example, by up-sampling, interpolation and/or filtering of the respective receive signal and/or by selecting a partial signal from the respective receive signal, in particular to reduce the computing requirement and therefore the energy requirement of the calculation.

Along with the method according to the invention, the invention relates to a measuring device for determining a measured quantity relating to the flow of a fluid through a measuring tube, containing a measuring tube guiding the fluid, at least two ultrasonic transducers arranged in or on the measuring tube, and a control device which is configured to control the ultrasonic transducers, to capture receive signals via the ultrasonic transducers and to determine the measured quantity depending on the receive signals. The control device is configured to carry out the method according to the invention.

Other features which are considered as characteristic for the invention are set forth in the appended claims.

Although the invention is illustrated and described herein as embodied in a method and a measuring device for determining a measured quantity relating to a flow, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, sectional view of an exemplary embodiment of a measuring device according to the invention;

FIG. 2 is a block diagram showing a sequence of one exemplary embodiment of the method according to the invention;

FIG. 3 is an illustration showing excitation signals usable in the method according to the invention and resulting receive signals;

FIGS. 4 and 5 are graphs showing cross-correlations of receive signals in exemplary embodiments of the method according to the invention; and

FIG. 6 is a block diagram showing steps for determining a suitable excitation signal in one exemplary embodiment of the method according to the invention.

### DETAILED DESCRIPTION OF THE INVENTION

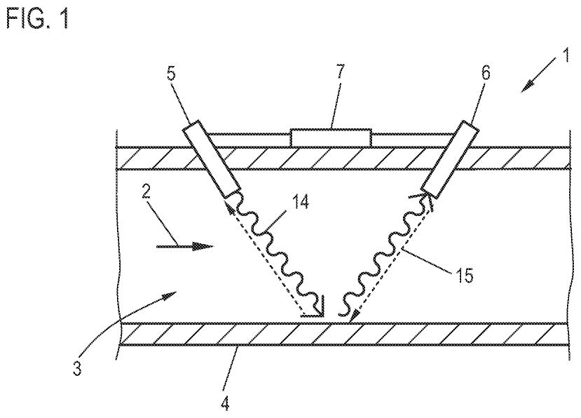

Referring now to the figures of the drawings in detail and first, particularly to FIG. 1 thereof, there is shown a measuring device 1 for determining a measured quantity relating to the flow of a fluid 3 through a measuring tube 4, in particular a flow rate or a flow volume. The fluid 3 flows here through the measuring tube 4 in the direction shown by an arrow 2. A control device 7 controls, on one hand, the ultrasonic transducer 5 as the transmitting ultrasonic transducer in order to transmit the ultrasonic signal 14 in the direction of flow, the ultrasonic signal 14 being received by the ultrasonic transducer 6 following a reflection on the tube wall, wherein the corresponding receive signal is captured by the control device 7 via the receiving ultrasonic transducer 6. Conversely, the control device 7 controls the ultrasonic transducer 6 as the transmitting transducer in order to transmit the ultrasonic signal 15 against the direction of flow to the now receiving ultrasonic transducer 5, via which a corresponding receive signal is captured by the control device 7.

On the basis of these two receive signals, a transit time difference can be determined between the transit time of the ultrasonic signal 14 from the ultrasonic transducer 5 to the ultrasonic transducer 6 and the transit time of the ultrasonic signal 15 from the ultrasonic transducer 6 to the ultrasonic transducer 5, wherein, as is well known per se, the transit time difference correlates with the flow rate of the fluid 3 so that, with a known measuring tube geometry, a volume flow can be determined for the fluid 3.

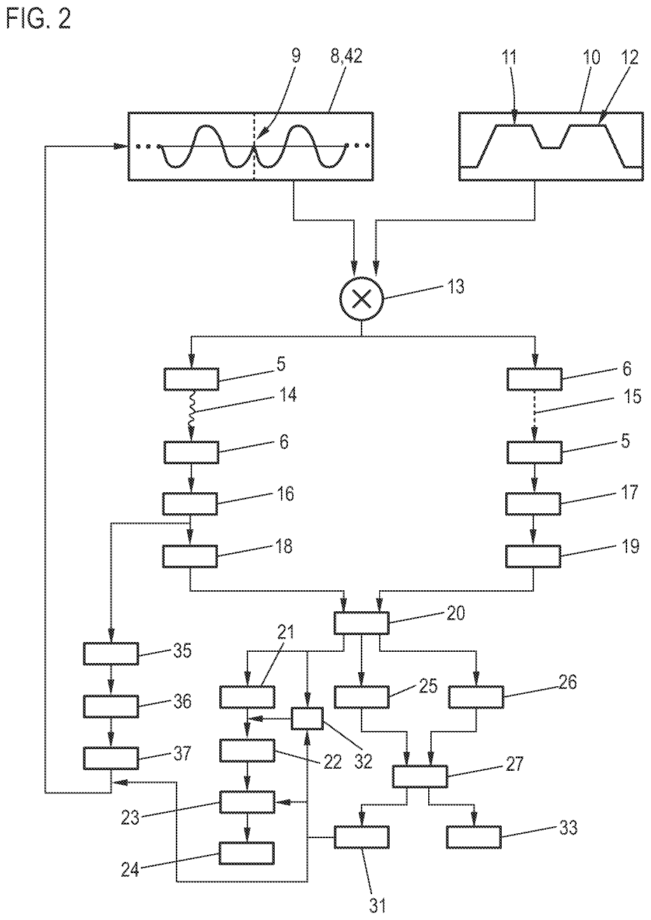

Details relating to a method implemented by the control device 7 to determine a measured quantity 24, for example the flow volume, are explained below with additional reference to FIG. 2.

An excitation signal 8, 42 having a fixed carrier frequency and amplitude is initially provided, whereupon an amplitude modulation 13 of the excitation signal 8 is performed with an envelope 10. Alternatively, it would also be possible to generate the excitation signal 8, 42 directly with a time-variable amplitude which is predefined by a corresponding envelope 10. The amplitude-modulated excitation signals 8, 42 are fed, typically in succession, to the ultrasonic transducers 5, 6, as a result of which the latter emit the ultrasonic signals 14, 15, the reception of which in the respective other of the ultrasonic transducers 5, 6 enables the provision of the respective receive signals 16, 17 to the control device 7. Optionally, a processing signal 18, 19 can first be determined from the respective receive signal 16, 17, for example by up-sampling, filtering and/or a scaling, in particular a normalisation. Alternatively or additionally, a partial signal can be selected from the respective receive signal in order to determine the processing signal. The computing requirement and therefore the energy requirement of the calculation can be reduced by restricting the cross-correlation to partial signals.

A cross-correlation 20 of the receive signals 16, 17 or the processing signals 18, 19 is then performed. The cross-correlation 20 of two signals x, y, which is denoted here as R_{xy}, can be calculated as follows:

R_{xy}(τ)=∫_{-∞}^{∞}x(t)·y(t+τ)dt.

With a time-discrete capture of the receive signals, the integral can also be expressed as the sum of the individual samples.

Optionally, the cross-correlation 20 can itself also be normalised, for example scaled depending on the amplitudes of the autocorrelations of the receive signals or intermediate signals, as already explained above, or by dividing the function R_{xy} by the value of this function at τ=0.

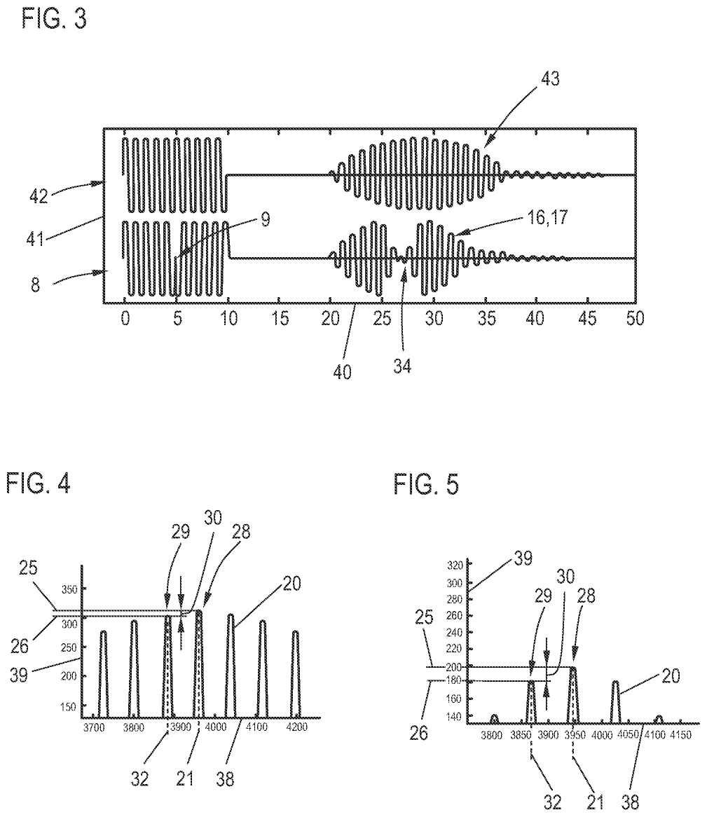

Examples of the signals that are used and the resulting cross-correlations are discussed below with additional reference to FIGS. 3 to 5. It is initially assumed here that the envelope 10 is a rectangular function, so that the respectively used excitation signal 8, 42 is output on the respective ultrasonic transducers 5, 6 for a number of cycles with a fixed amplitude and the control is then abruptly ended.

In a first example which is shown in the top line in FIG. 3, a normal sinusoidal oscillation is used as the excitation signal 42. The x-axis 40 indicates the time characteristic in μs and the y-axis 41 indicates the amplitude. The receive signal 43, for example, is produced due to the transmission characteristics of a normal measuring distance with the use of this excitation signal 43.

If two receive signals 43 of this type are cross-correlated, the cross-correlation 20 shown in FIG. 4 is produced as a result. A sample number, and therefore ultimately a time, is plotted here on the x-axis, and the amplitude of the cross-correlation 20 is plotted in any given units on the y-axis. In order to highlight the discussed features more clearly, FIG. 4 and FIG. 5 show only a relatively small section of the respective cross-correlation 20 representing the highest maxima of the respective cross-correlation 20. FIG. 4 shows that the height 25 of the main maximum 28 differs from the height of the next-highest secondary maximum 29 by only a small differential amount 30. Even relatively slight interference in the measurement can thus result in the secondary maximum 29 rather than the main maximum 28 being identified as the main maximum. Since the time axis of the cross-correlation correlates with the transit time difference, this would result in a substantial measurement error for the transit time difference and therefore for the measured quantity also.

As will be explained later, corresponding interference can normally be identified by evaluating a trigger condition 27 and can elicit a corresponding response so that, in principle, a robust determination of the measured quantity using the excitation signal 42 is also possible. However, an approach for reducing the risk of a measurement error of this type from the outset will first be explained below.

As shown in FIG. 2 and in the bottom line of FIG. 3, an excitation signal 8 having a phase shift 9, in the example of 180°, can be used. Alternatively, other sizes of the phase shift, for example 90° or 270°, or values in between, can also be used. A phase shift through 180° is particularly simple to implement, since it can be produced e.g. by inverting the signal at the zero crossing. However, if the excitation signal is, for example, digitally generated and converted via an analogue-to-digital converter into an analogue control signal before or after the amplitude modulation by the envelope 10, phase shifts of any size can be implemented without additional hardware outlay.

The receive signal 16, 17 resulting from an excitation of this type is similarly shown in FIG. 3. This also has a phase shift in the area 34 and the amplitude of the signal is significantly reduced in this area 34. The cross-correlation 20 of two receive signals 16, 17 of this type is shown in FIG. 5. Compared with the cross-correlation shown in FIG. 4, it is evident that the height 25 of the main maximum 28 is significantly reduced through the use of the phase shift 9, but the height 26 of the secondary maxima 29 is even more significantly reduced in comparison, resulting, both relatively and absolutely, in an even greater differential amount 30 than would occur without the use of this phase shift 9. The main maximum 28 and therefore its position 21 can thus be identified significantly more robustly by using the phase shift 9 in the excitation signal 8.

A similarly substantial lowering of the height of the secondary maxima 29 can also be achieved without the use of a phase shift 9 if, as shown in FIG. 2, an envelope 10 having a plurality of temporally spaced maxima 11, 12 is used. Both approaches can obviously also be combined, as shown in FIG. 2.

Again with reference to FIG. 2, following the determination of the cross-correlation 20, the position 21 of the main maximum 28 can be obtained therefrom, for example by locating the global maximum. This position 21 corresponds to the time shift between the receive signals 16, 17 with which the latter are as similar as possible to one another and therefore to the transit time difference 22 of the ultrasonic signals 14, 15. Depending on how the time window is chosen during which measurement data are acquired for the receive signals 16, 17, the position 21 of the main maximum 28 can also differ by a fixed offset from the transit time difference.

The measured quantity 24, i.e., for example, a flow rate or flow volume over time, can therefore be determined from the transit time difference 22 by means of a determination rule 23. In the simplest case, the determination rule 23 can involve a multiplication by a predefined constant, but it is also possible to take account of non-linearities, for example due to a change in the flow profile depending on the flow rate, for example by using a look-up table or a defined mathematical relationship as the determination rule 23 or as part thereof.

Particularly if an excitation signal without a phase shift 9 is used as the excitation signal 42, and a simple envelope, for example a rectangular envelope, is used, but also in the other cases discussed above, it is appropriate to check on the basis of the captured receive signals 16, 17 whether a robust determination of the measured quantity 24 is likely to be possible or whether, for example, maintenance of the measuring device or a new determination of measurement data is required due to interference or a manipulation attempt.

For this purpose, as shown in FIG. 2, the heights 25, 26 of the main and secondary maximum 28, 29 can be determined from the cross-correlation 20, whereupon a trigger condition 27 depending on these quantities or at least one of these quantities can be evaluated. The effects of different interferences and influences on the heights 25, 26 of the main maximum 28 and the secondary maxima 29 have already been explained in detail in the general part, so that only individual points will be singled out here by way of example. Time characteristics, for example, of the heights 25 or 26 can be recorded via a multiplicity of measurements, and ageing processes can be identified on the basis of the change over time in the heights 25, 26 and thus, for example, a message 33 can be output to a user or to a further device in order to indicate a maintenance requirement. A message 33 of this type can also be output, for example, if interference is detected repeatedly or with a certain frequency or said interference cannot be compensated by adjusting 31 the determination of the measured quantity 24 compared with the normal operating mode.

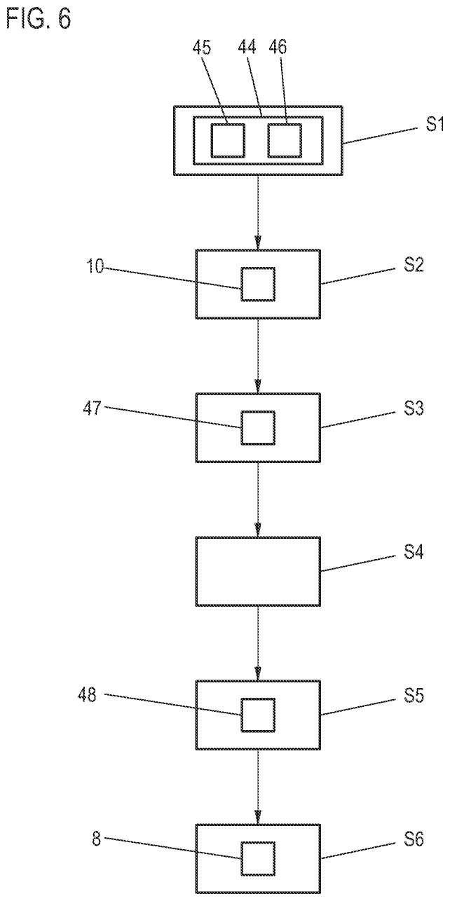

A multiplicity of options which have already been discussed in the general part are available for adjusting 31 the determination of the measured quantity 24. Only some examples of adjustments 31 will therefore be mentioned below. It is thus possible, for example, to reject the previously captured receive signals 16, 17 if the trigger condition 27 is fulfilled and to carry out a new determination, i.e. to repeat the sequence shown in FIG. 2 from the start. It is possible here, in particular, for the carrier frequency and/or the size of the phase shift 9 of the excitation signal 8 to be modified. The procedure explained later with reference to FIG. 6, for example, can be used for this purpose.

However, instead of a new determination, it would also be possible, for example, initially to continue to use the measured quantity determined in a preceding iteration and to determine the measured quantity again only at a later time at which the trigger condition, for example, is no longer fulfilled.

As similarly already described in the general part, the evaluation of the trigger condition 27 can, however, also serve to identify measurement situations with a high flow through the measuring tube. In this case, it can be advantageous to retain the receive signals 16, 17 and to modify only the subsequent further processing of the resulting cross-correlation 20. The determination rule 23, for example, can be modified by taking account of non-linear effects at high flow rates or turbulences in the flow. In some cases, however, it can also be appropriate to use the position 32 of the secondary maximum 29 instead of the position 21 of the main maximum 28 to determine the measured quantity 24 or the transit time 22. This can be the case, for example, if the heights 25, 26 of the main and secondary maximum 28, 29 are very similar and, at the same time, the position 21 of the main maximum 28 indicates a relatively low flow, whereas, for example, the height 25 of the main maximum 28 indicates more of a weak correlation due to the distortion of one of the receive signals 16, 17 due to a high flow.

The quality of the receive signals 16, 17 and therefore the robustness of the determination of the measured quantity 24 can further be monitored by evaluating a spectral condition 37 which, for the sake of clarity, is shown for only one of the receive signals 16. The spectral composition 35 of the respective receive signal 16, 17 can first be determined for this purpose and the frequency range 36 in which the frequencies of the receive signal 16, 17 have the maximum amplitude can then be determined. The spectral condition 37 can be fulfilled, for example, if the frequency of the excitation signal 8, 42 lies outside this frequency range 36, since it can indicate, for example, a detuned resonant frequency of one of the ultrasonic transducers due to ambient conditions, damage, or for other reasons.

In particular, if the spectral condition 37 is fulfilled, the carrier frequency and/or the size of the phase shift 9 of the excitation signal 8, 42 that is used can be adjusted during the next determination of the receive signals 16, 17 or during a repetition of the determination of the receive signals 16, 17.

FIG. 6 shows steps S1-S6 which can be used in order to define a suitable excitation signal 8. These steps can be carried out, for example, during a calibration of the measuring device 1 following manufacture or following installation at the location of use or also if, for example, the trigger condition 27 or the spectral condition 37 is fulfilled, in order to determine a suitable carrier frequency or a suitable size of the phase shift 9. Here, in step S1, a plurality of different test excitation signals 44 are first provided or generated which differ from one another in terms of their carrier frequency 45 and/or the size 46 of the phase shift 9.

In step S2, the respective test excitation signal 44 is multiplied or amplitude-modulated by the envelope 10 and output to one of the ultrasonic transducers 5, 6.

In step S3, assigned test receive signals 47 are received via the respective other ultrasonic transducer. In step S4, a Fourier transform is then performed in each case for a plurality of windows of these test receive signals 47, wherein not only the amplitude for a respective frequency, but also a phase is determined. The size 48 of the phase shift of the respective test receive signal 47 can be determined by comparing the phases of the dominant frequency in adjacent windows.

In step S6, the test excitation signal 44 for which the size 48 of the phase shift of the resulting test receive signal 47 was greatest is then selected as the excitation signal 8.

The following is a summary list of reference numerals and the corresponding structure used in the above description of the invention.

### REFERENCE NUMBER LIST

1 Measuring device

2 Arrow

3 Fluid

4 Measuring tube

5 Ultrasonic transducer

6 Ultrasonic transducer

7 Control device

8 Excitation signal

9 Phase shift

10 Envelope

11 Maximum

12 Maximum

13 Amplitude modulation

14 Ultrasonic signal

15 Ultrasonic signal

16 Receive signal

17 Receive signal

18 Processing signal

19 Processing signal

20 Cross-correlation

21 Position

22 Transit time difference

23 Determination rule

24 Measured quantity

25 Height

26 Height

27 Trigger condition

28 Main maximum

29 Secondary maximum

30 Differential amount

31 Adjustment

32 Position

33 Message

34 Area

35 Spectral composition

36 Frequency range

37 Spectral condition

38 X-axis

39 Y-axis

40 X-axis

41 Y-axis

42 Excitation signal

43 Receive signal

44 Test excitation signal

45 Carrier frequency

46 Size

47 Test receive signal

48 Size

S1-S6 Step

1. A method for determining a measured quantity relating to a flow of a fluid through a measuring tube by means of a measuring device, which comprises the steps of:
emitting, for two propagation directions, an ultrasonic signal in each case by a transmitting ultrasonic transducer of the measuring device and being transmitted via the fluid to a receiving ultrasonic transducer of the measuring device, wherein a receive signal is captured via the receiving ultrasonic transducer for a respective propagation direction;
depending on a position of a main maximum of a cross-correlation of receive signals for the two propagation directions or a cross-correlation of processing signals which depend in each case on one of the receive signals or on a partial signal of the receive signal, a transit time difference between transit times of a respective ultrasonic signal for the respective propagation direction from the transmitting ultrasonic transducer to the receiving ultrasonic transducer is determined;
determining the measured quantity in dependence on the transit time difference, wherein the transmitting ultrasonic transducer being controlled in each case with an excitation signal, the excitation signal having a fixed carrier frequency, the excitation signal having a phase shift and/or an envelope with a plurality of temporally spaced maxima; and
determining if a trigger condition is fulfilled, a fulfilment of the trigger condition depending on a height of the main maximum and/or of at least one secondary maximum of the cross-correlation, the determining of the measured quantity is modified compared with a normal operating mode and/or a message is output to a user of the measuring device and/or to a further device outside the measuring device if the trigger condition exists.

2. The method according to claim 1, wherein if the trigger condition is fulfilled, modifying a determination of the measured quantity compared with the normal operating mode in such a way that the receive signals are rejected and either a previously determined measured quantity is used as a current measured quantity or a determination of the receive signals is repeated in order to provide new receive signals, wherein the determination of the new receive signals is performed either unchanged or with at least one modified determination parameter compared with the determination of the receive signals, and the measured quantity is determined on a basis of the new receive signals, and/or the transit time difference is determined depending on a position of one of the at least one secondary maxima of the cross-correlation and/or a determination rule is modified in order to determine the measured quantity from the transit time difference.

3. The method according to claim 1, wherein if the trigger condition is fulfilled and/or a spectral condition depending on a spectral composition of at least one of the receive signals is fulfilled, a second determination of the receive signals is carried out following a first determination of the receive signals, wherein the fixed carrier frequency of the excitation signal and/or a size of the phase shift is modified compared with the first determination.

4. The method according to claim 3, wherein a fulfilment of the spectral condition depends on a frequency range in which frequencies have a maximum amplitude in a respective one of the receive signals or in a selected time segment of the receive signal.

5. The method according to claim 1, which further comprises determining the receive signals multiple times in temporal succession for the propagation directions and the cross-correlation, wherein a time characteristic of the height of the main maximum and/or at least one of the secondary maxima of the cross-correlation and/or a time characteristic of a processing result which depends on heights of the main maximum and at least one of the secondary maxima is recorded, wherein the fulfilment of the trigger condition depends on the time characteristic.

6. The method according to claim 1, which further comprises emitting a test ultrasonic signal multiple times by the transmitting ultrasonic transducer and the test ultrasonic signal is transmitted via the fluid to the receiving ultrasonic transducer for at least one of the propagation directions before a transmission of the ultrasonic signal, wherein a respective test receive signal is captured via the receiving ultrasonic transducer, wherein the transmitting ultrasonic transducer is controlled to emit the test ultrasonic signal in each case with a test excitation signal, wherein test excitation signals differ from one another in terms of their carrier frequency and/or a size of their phase shift, wherein the test excitation signal for which a maximum phase shift and/or a maximum separation of local maxima of an envelope of the test receive signal occur in a resulting test receive signal is chosen as the excitation signal for determining the transit time difference.

7. The method according to claim 6, which further comprises determining a size of the phase shift by performing a Fourier transform in each case for a plurality of windows of the test receive signal.

8. The method according to claim 1, wherein the fulfilment of the trigger condition depends on a difference and/or a quotient of the height of the main maximum and the height of one of the at least one secondary maxima.

9. The method according to claim 1, wherein the fulfilment of the trigger condition depends on the height of the main maximum and/or the at least one secondary maximum of the cross-correlation of the processing signals, wherein a respective processing signal of the processing signals is determined through normalization of the receive signal or of a respective intermediate signal determined from the receive signal and/or in that, the height of the main maximum and of the at least one secondary maximum of the cross-correlation is determined following a normalization of the cross-correlation.

10. The method according to claim 6, wherein the test excitation signal is amplitude-modulated by the envelope.

11. The method according to claim 8, wherein the height of one of the at least one secondary maxima is derived from a highest secondary maximum.

12. A measuring device for determining a measured quantity relating to a flow of a fluid through a measuring tube, the measuring device comprising:
a measuring tube guiding the fluid;
at least two ultrasonic transducers disposed in or on said measuring tube; and
a controller configured to control said at least two ultrasonic transducers, to capture receive signals via said at least two ultrasonic transducers and to determine the measured quantity depending on receive signals, said controller is configured to carry out the method according to claim 1.
